(19) United States
(12) Patent Application Publication
(10) Pub. No.: US 2008/0157560 A1
(43) Pub. Date: Jul. 3, 2008

(54) Apparatus for reducing the drag of vehicles in motion

(76) Inventor: Samuel Spector, Edison, NJ (US)

Correspondence Address: SAMUEL SPECTOR, 14 BROOKFALL RD., EDISON, NJ, 08817, US

(21) Appl. No.: 11/646,066

(22) Filed: Dec. 28, 2006

(51) Int. Cl. B60J 1/20

(52) U.S. Cl. 296/180.4

(57) ABSTRACT

Apparatus attached to the rear of a large box like vehicle for reducing rear drag, resulting from the movement of the vehicle includes an aerodynamically shaped structure rotatably mounted along at least one of the rear edges of said vehicle. The structure defines an enclosed space facing the rear of the vehicle which extends beyond the rear edges of the vehicle thereby increasing the length of the body of the vehicle and at the same time increasing the storage capacity of the vehicle. In one embodiment the structure includes two doors rotatably mounted along the vertical edges of the rear of the vehicle. The two doors, when closed, form an aerodynamic drag reducer. When access to the rear cargo doors is required the drag reducing doors are unlocked and/or unlatched and swung open to the sides of the vehicle.

### BACKGROUND OF THE INVENTION

This invention relates to apparatus for reducing the drag associated with box-like vehicles when in motion.

It is known that the box like configuration of the rear of vehicles such as trucks and trailers results in the creation of “drag” which is particularly noticeable at higher speeds. Drag present at the rear of a vehicle is basically the result of reduced air pressure created at the rear of the vehicle and becomes more pronounced as the vehicle is operated at higher speeds. Drag causes an increase in fuel consumption. It decreases the efficiency of the vehicle and increases the cost of operation. To reduce drag the attachment of various aerodynamic structures to the rear of a vehicle have been proposed. For example, U.S. Pat. Nos. 4,142,755, 4,257,641 and 4,741,569 are cited as some of the many attempts to deal with this problem

However, known suggestions to deal with the rear drag of a vehicle have proven to be impractical and/or cumbersome. In particular, none of the known solutions provide an easy access to a vehicle's rear cargo doors.

It is an object of the invention to provide a structure which can be attached to the rear of a vehicle for reducing the vehicle's drag while enabling easy access to the vehicle's cargo or cargo doors.

### SUMMARY OF THE INVENTION

Apparatus embodying the invention includes an aerodynamically shaped structure which can be attached to the rear of a box like vehicle in a manner which allows easy access to the cargo and/or the cargo doors. The aerodynamic shape of the structure ensures that the drag exhibited by, and on, the vehicle is substantially reduced. The aerodynamically shaped structure may be in the form of double doors rotatably mounted about opposite edges of the rear of the vehicle, or in the form of a single door which is rotatably mounted about one of the edges of the rear of the vehicle. The aerodynamically shaped structure increases the length of the vehicle. But, in accordance with the invention the additional length is used to provide additional storage space. Structures embodying the invention may be mounted on vehicles already having cargo doors to provide drag reduction while also providing additional storage capacity and be operable to enable easy access to the cargo via the pre-existing cargo doors. That is, the door or doors of a structure embodying the invention may first be opened to gain access to preexisting cargo doors, which then have to be opened. Alternatively, the structures embodying the invention may be used exclusively as the cargo doors of new vehicles or retrofitted to be the only cargo doors of previously built vehicles, thereby eliminating the need for another set of cargo doors.

### BRIEF DESCRIPTION OF THE DRAWINGS

In the accompanying drawings like reference characters denote like components; and

FIG. 1 is an isometric view of doors embodying the invention mounted on the rear of a truck in accordance with the invention;

FIG. 1A is a top view of two triangularly shaped doors formed and mounted in accordance with the invention;

FIG. 1B is a top view of two curved doors formed and mounted in accordance with the invention;

FIG. 2 is a view of the doors shown in FIG. 1, in the open position;

FIG. 3 is an isometric view of doors formed in accordance with the invention and mounted on the rear of a truck having existing vertical cargo doors;

FIG. 4 is a drawing of doors suitable for use in the embodiment shown in FIG. 3, with the doors shown in the open position.

FIG. 5 is an isometric drawing of a wedge shaped drag reducing door formed in accordance with the invention;

FIG. 6 is a drawing of a side view of FIG. 5 showing a door formed in accordance with the invention having sloped top and bottom surfaces;

FIG. 7 is an isometric diagram of a door embodying the invention having a curved aerodynamic surface;

FIG. 8 is a top view of the door shown in FIG. 7;

FIG. 9 is a side view of a door formed in accordance with the invention having sloped top and bottom surfaces;

FIG. 10 is a view looking out from inside the truck showing the enclosed additional storage space formed by a structure embodying the invention;

FIG. 11 is a diagram of a single triangular door formed to provide drag reduction and additional storage space in accordance with the invention; and

FIG. 12 is a diagram of a single semi-circular (bowed) door formed to provide drag reduction and additional storage space in accordance with the invention.

### DETAILED DESCRIPTION OF THE INVENTION

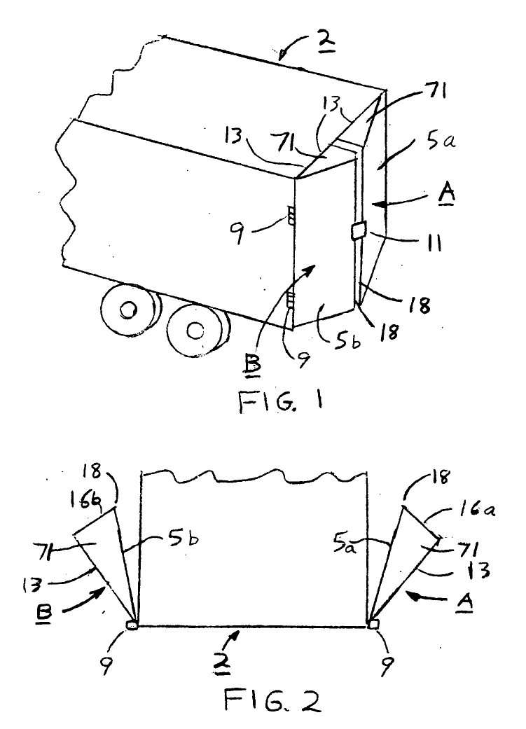

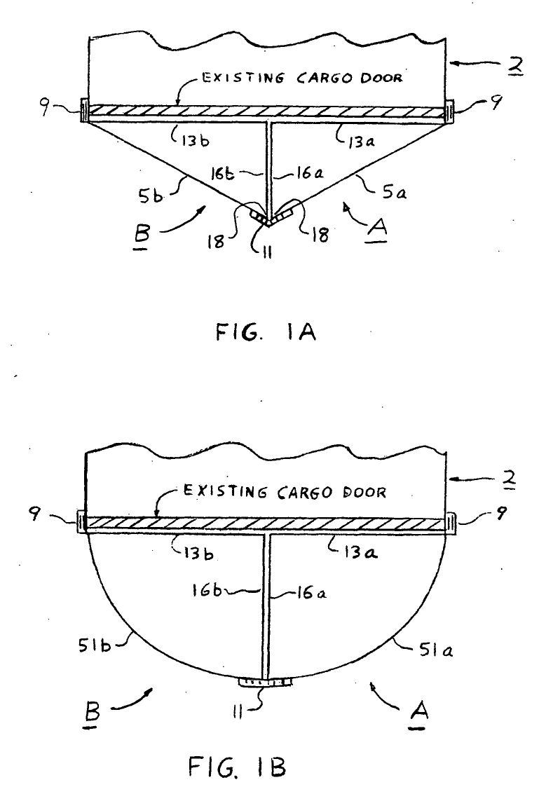

FIG. 1 shows two drag reducing doors A and B mounted on the rear of a truck 2, in the closed, drag reducing, position. FIG. 2, shows the doors in the open position. The doors A and B are mounted by means of hinges 9 located at, and along, the outer, vertical, edges of the truck. In the closed position, the side walls 16a, 16b of the two doors face each other along a line (and plane) which corresponds generally to the center of the truck's rear. The outer walls 5 (5a, 5b) of the doors are shaped to provide aerodynamic air flow and decreased turbulence and drag. Some possible shapes are shown and discussed herein. However, it should be understand that this is by way of example only and that the doors may have numerous different shapes to provide improved aerodynamic air flow.

By way of illustration, reference may be had to FIGS. 1, 1A, 2, 5, 6, and 10 which show that the doors may have a wedge-like, or triangular, configuration extending rearwardly beyond the rectangular rear wall edges of truck 2. FIG. 1A shows a top view of the doors of FIG. 1. Each one of the two doors has two solid sides or walls extending between solid upper and bottom sides to produce an open space (pocket) within the interior of the door while the exterior of the door is aerodynamically shaped to decrease turbulence and drag. In FIG. 1A, the outer door panels 5a, 5b, extend at a fixed angle from their respective mounting edges such that the thickness of the doors increases as their distance increases from their mounting edge; their thickness being maximum at the center of the rear of the truck 2, where their facing sides 16a, 16b abut each other. When closed the internal storage space existing within the doors face the cargo doors (if present) or the rear of the truck if there are no cargo doors. A latch 11 is provided to lock the doors. This latch may be any mechanism for securely holding the two doors together, but which can be easily opened or closed.

It should be appreciated that, in accordance with the invention, the exterior and side walls of doors A and B are made to provide an open space within the (triangular) extension which may be used as additional cargo space. The additional cargo space may include shelves as shown in FIG. 10. Alternatively, the space within the triangular extension may be left undefined to allow the contents of the main cargo space of truck 2 to extend within the triangular extension. Thus, the aerodynamically shaped doors embodying the invention reduce drag, thereby increasing the operating efficiency of the vehicle while providing additional storage space.

The embodiment of FIGS. 1 and 2 may be used with existing trucks having a pre-existing roll up cargo door. That is, existing trucks with roll up doors may be retrofitted with doors embodying the invention. Alternatively, cargo doors of existing trucks which do not provide drag reduction may be removed and replaced by doors embodying the invention. Still further, it is anticipated that new trucks may be manufactured with doors embodying the invention.

FIG. 2 is a top view illustrating the drag reducing doors A and B in the open position. Note that the doors are rotated about hinges 9. The mounting of the drag reducing doors with hinges along the rear vertical edges of the truck is suitable for a truck with roll-up cargo doors. When in the closed position, doors A and B form a drag reducing structure having a vertical outer edge 18. In the closed position the inner door sides 16 (16a, 16b) face each other. The sides may be provided with a resilient type gasket material for an airtight seal. The resilient gasket material may also be provided along the edges of plane 13 (see edges 13bu, 13bl, 13bi and 13bo in FIG. 10) and the rear edges of the rectangular outer walls of truck 2.

FIGS. 5, 6 and 10 are more detailed views of triangularly shaped doors suitable for forming the double doors embodying the invention. An examination of these figures shows that, in one embodiment, each one of the double doors may be generally wedge shaped and include two solid side walls (5 and 16) and two solid top and bottom wall panels 71 and 81. Wall 5 is the outer panel/wall of door A or B. Sidewalls 16 (16a or 16b) extending in a generally perpendicular direction from an internal edge 13i to outer edge 18 of outer wall 5. The width of the sidewall 16 may range from a few inches to more than one half the width of the rear of the vehicle. Upper door panel/wall 71 defines a plane extending horizontally from walls 5 and 16 to the top of horizontal inner edge 13u. Bottom door panel/wall 81 defines a plane extending horizontally from walls 5 and 16 to the bottom horizontal inner edge 13l.

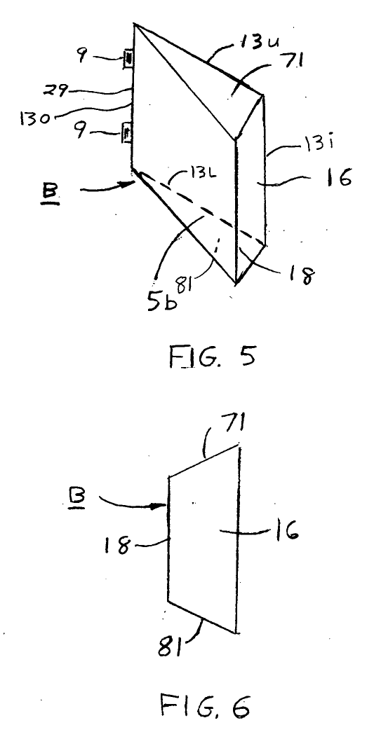

FIG. 6 illustrates that the upper panel 71 may slope down and that bottom panel 81 may slope up to reduce turbulence and drag exhibited by the vehicle when operated at high speeds.

FIG. 1B shows a top view of doors A and B whose exterior portions 51a, 51b have a generally concave shape. In FIG. 1B, the outer door portions 51a, 51b, curve (or bow) out such that the thickness of the doors is the least near the hinged (outer) edge of the door and increases as their distance increases from their mounting edge towards the inner edge of the doors. The thickness of the doors being greatest at or near the center of the truck, where their facing sides 16a, 16b abut each other. When the doors are closed, the internal surfaces 13a, 13b of the doors face the cargo doors (if present) or the rear of the truck's cargo space if there are no cargo doors. A latch 11 is provided to lock the doors. The doors of FIG. 1B may be used as discussed above for the doors of FIGS. 1 and 1A.

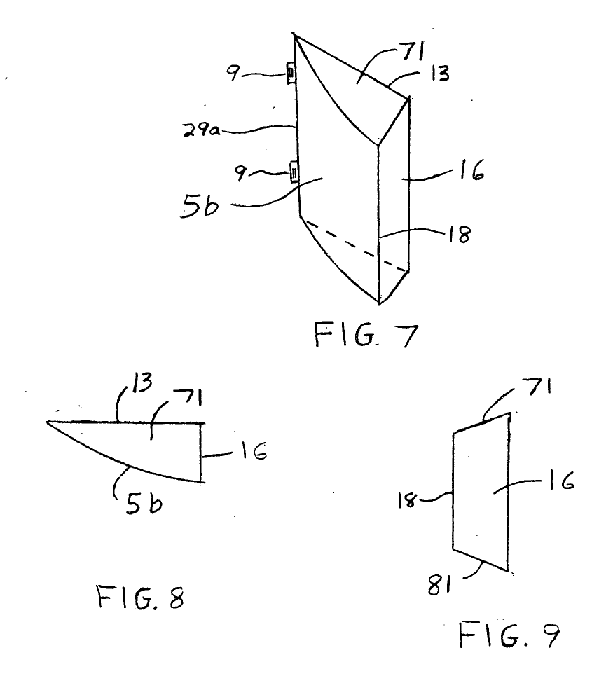

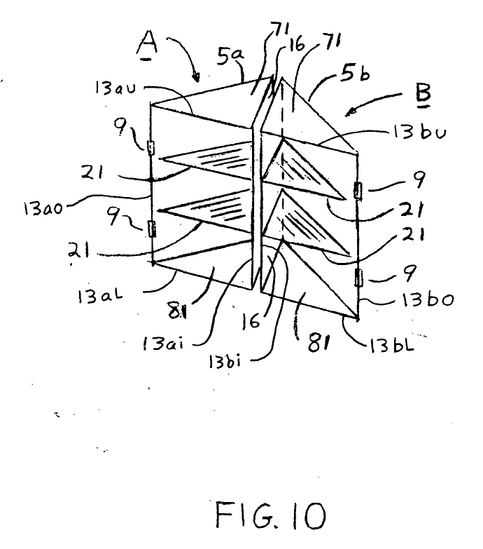

FIGS. 7, 8 and 9 illustrate in greater detail the formation of a door suitable for use in the embodiment shown in FIG. 1B. FIGS. 7 and 8 show that the door may have a curved outer wall 5 (5a, 5b) instead of the straight wall shown in FIG. 5. The outer wall 5 extends in a curve from the outer edge 29a towards the outer edge (apex) 18 of the door to provide a desired aerodynamic shape for reducing drag. The upper and bottom side walls 71 and 81 shown in FIG. 9 may be sloped as shown in FIGS. 6 and 9. The double doors are made to close comfortably upon each other and to operate together. It should be evident that the hinged arrangement allows the doors to be opened and closed easily and to give easy access to the contents of the cargo within the box of the truck.

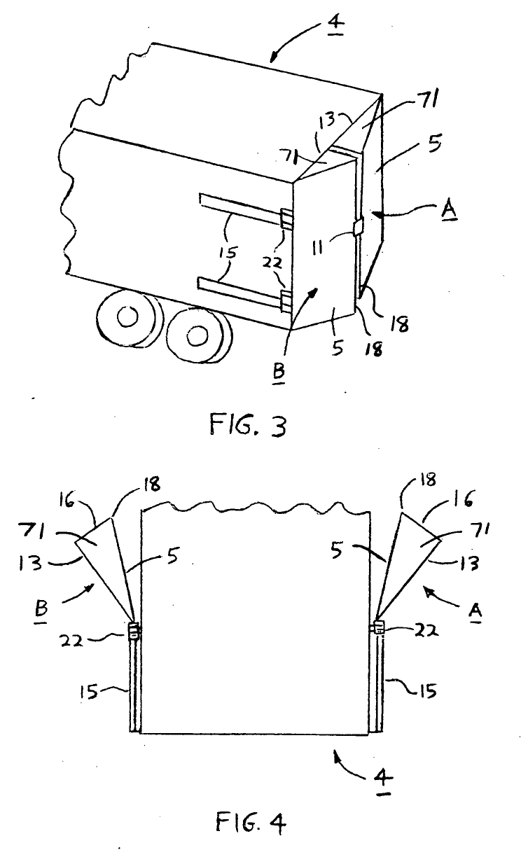

FIGS. 3 and 4 shows drag reducing doors A and B mounted on the rear of a truck 4, which is a truck having vertical cargo doors which swing open to the sides of the truck. This necessitates that doors embodying the invention be mounted on the truck differently than as shown in FIGS. 1 and 2. FIGS. 3 and 4 are intended to show that drag reducing doors A and B are mounted to truck 4 via hinges 22 which are connected to the drag reducer doors A and B and slideably connected to tracks 15, the tracks 15 being secured to the sides of truck 4. Thus, the drag reducing doors can be opened and slid towards the front of the truck 4 a sufficient distance to allow access to the truck's pre-existing cargo doors so they can be easily and fully opened.

Although the drawings show the invention mounted on existing vehicles, the drag reducing doors can also be provided as replacements doors on existing vehicles or as new doors for new vehicles; thereby, eliminating the need for additional cargo doors.

The interior of the drag reducing doors as shown in FIG. 10 can be provided with shelving 21 and/or means for storage; thus, the invention in addition to reducing a vehicle's drag provides an additional benefit in that it can increase the vehicle's storage capacity. It should also be noted that the shelving within the door space provides additional stiffening support to the doors.

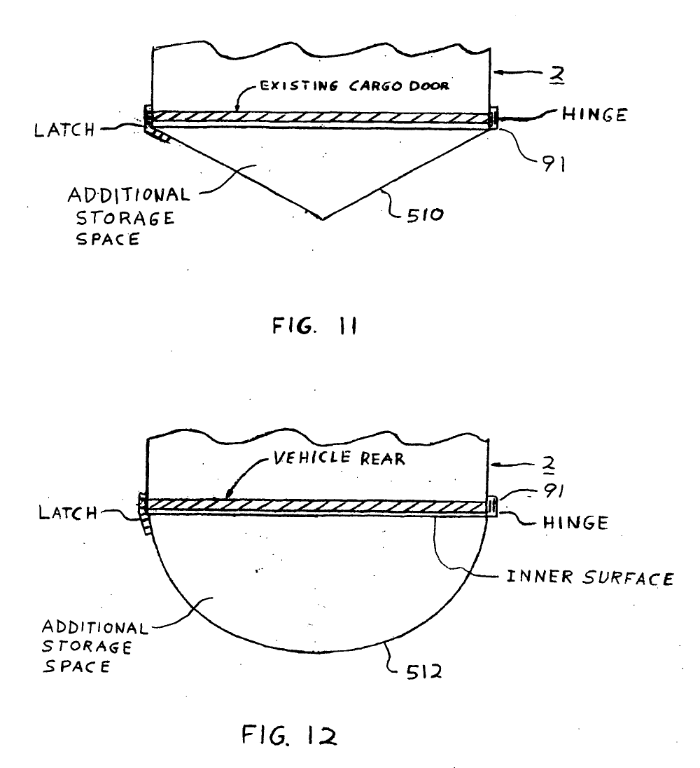

FIGS. 11 and 12 are intended to show that a single door 510 or 512 may be used to provide the desired aerodynamic air flow for reducing drag and turbulence and also provide additional storage capacity. The single door is mounted via a hinge 91 for rotatably (as in FIGS. 1 and 2) or slidably (as in FIGS. 3, 4) opening and closing the door. The single door structure may provide an advantage where undivided storage space is desired.

What is claimed is:

1. Apparatus attached to the rear of a large box like vehicle for reducing rear drag, resulting from the movement of the vehicle comprising:
the rear of said vehicle having lower and upper horizontal edges and having left and right vertical edges;
an aerodynamically shaped structure rotatably mounted along at least one of the rear edges of said vehicle; the structure defining an enclosed space facing the rear of the vehicle and extending beyond the rear edges of the vehicle thereby increasing the length of the body of the vehicle and the structure being configured to increase the storage capacity of the vehicle.

2. An apparatus as claimed in claim 1, wherein the structure includes double doors, each door having: (a) an outer vertical end and an inner vertical end, (b) an upper surface and a lower surface; and (c) a solid outer surface; the distance between the inner and outer vertical ends defining the width of the door, the width of each door being approximately equal to one half the distance between the left and right vertical edges of the rear of the vehicle, each door being rotatably mounted at its outer vertical end along a rear vertical edge of the vehicle, the inner vertical ends of the two doors facing each other when the doors are closed; the distance between the solid outer surface and a plane defined by the horizontal and vertical edges of the rear of the vehicle defining the thickness of the door and the increase in storage space, and the thickness of each door increasing gradually along the width of the door as the door extends from its outer end to its inner end with the distance of the outer surface being increasingly greater relative to the rear of the vehicle to provide reduced drag and at the same time providing increased storage space.

3. An apparatus as claimed in claim 2, wherein the outer surface of each door is shaped like an arc whereby when the doors are closed they form a bow shaped structure.

4. An apparatus as claimed in claim 2, wherein the thickness of each door increases linearly as the door extends from the outer end to its inner end, each door forming a right-triangular type of structure and the two doors, when closed, forming an isosceles like structure.

5. An apparatus as claimed in claim 2, wherein shelves are mounted within the enclosed space of each door.

6. An apparatus as claimed in claim 2 wherein the upper surface of each door slopes downward and the lower surface of each door slopes upward to reduce turbulence and drag.

7. An apparatus as claimed in claim 1 wherein the rear of the vehicle includes a cargo door and wherein the structure is mounted so as to be moved out of the plane of the cargo door to enable the cargo door to be opened and closed, and the cargo accessed, independently of the structure.

8. An apparatus as claimed in claim 1 wherein the structure includes a door having an outer vertical end rotatably mounted along one of the two vertical edges of the rear of the vehicle and having another vertical end attachable to the other vertical edge of the vehicle, the door having an upper surface and a lower surface and a solid outer surface; the distance between the solid outer surface and a plane defined by the horizontal and vertical edges of the rear of the vehicle defining the thickness of the door and the increase in storage space provided by the door.

9. An apparatus as claimed in claim 8 wherein shelves are formed within the enclosed space of the door to provide for additional storage.

10. An apparatus as claimed in claim 8 wherein the outer surface of the door is bow shaped.

11. An apparatus as claimed in claim 8 wherein the outer surface of the door is shaped like an isosceles triangle.

12. An apparatus as claimed in claim 2 wherein the double doors are rotatably and slidably mounted with retractable sections along the sidewalls of the vehicle to enable full access to the rear of the vehicle.

13. Apparatus for reducing the air drag of large box like vehicles, comprising:
double doors extending from the rear sidewalls of the vehicle and meeting midway between the opening formed by the sidewalls; the doors being shaped such that their thicknesses increases gradually as the distance from the sidewall for providing drag reduction and increasing the storage capacity of the vehicle and the doors being rotatably and retractably mounted.
